(19) United States
(12) Patent Application Publication
(10) Pub. No.: US 2026/0055272 A1
(43) Pub. Date: Feb. 26, 2026

(54) AQUEOUS MOISTURE-PERMEABLE WATERPROOF COMPOSITION

(71) Applicant: LEGO STONE CO., LTD., Taichung City (TW)

(72) Inventor: Chung-Hao CHANG, Taichung City (TW)

(21) Appl. No.: 18/989,341

(22) Filed: Dec. 20, 2024

(30) Foreign Application Priority Data
Aug. 20, 2024 (TW) 113131267

(51) Int. Cl. C08L 75/08; C08J 9/00; C08J 9/30; C08K 5/42; C08L 75/06

(52) U.S. Cl. CPC C08L 75/08; C08J 9/0061; C08J 9/30; C08K 5/42; C08L 75/06; C08J 2375/06; C08J 2375/08; C08J 2475/08; C08L 2203/14; C08L 2312/00

(57) ABSTRACT

An aqueous moisture-permeable waterproof composition includes an aqueous polyurethane resin having a weight average molecular weight ranging from 1000 g/mol to 10000 g/mol, an aqueous crosslinking agent, and an aqueous foaming agent. The aqueous moisture-permeable waterproof composition is free from a solvent. The aqueous crosslinking agent is present in an amount ranging from 0.1 parts by weight to 15.0 parts by weight and the aqueous foaming agent is present in an amount ranging from 0.1 parts by weight to 15.0 parts by weight, based on a total amount of the aqueous polyurethane resin as 100 parts by weight. The aqueous crosslinking agent is selected from the group consisting of an isocyanate-based aqueous crosslinking agent, an epoxy-based aqueous crosslinking agent, an aziridine-based aqueous crosslinking agent, a melamine-based aqueous crosslinking agent, and combinations thereof.

### CROSS-REFERENCE TO RELATED APPLICATION

This application claims priority to Taiwanese Invention Patent Application No. 113131267, filed on Aug. 20, 2024, the entire disclosure of which is incorporated by reference herein.

### FIELD

The present disclosure relates to an aqueous moisture-permeable waterproof material, and more particularly to an aqueous moisture-permeable waterproof composition which is free from a solvent.

### BACKGROUND

In recent years, with growing popularity of outdoor activities such as camping, hiking, and running, the performance of outdoor products such as tents, clothing, and shoes have gained increasing attention, particularly in terms of moisture permeability, waterproofness, and wash durability. Conventional films used in outdoor products are made from oily solvent-containing resins, which release environmentally harmful volatile organic compounds (VOCs) during production. As environmental awareness grows, manufactures are increasingly focusing on developing aqueous eco-friendly resins that do not emit VOCs. Aqueous polyurethane resins are the most common of aqueous co-friendly resins, among others. However, the moisture permeability, waterproofness, and wash durability of the aqueous polyurethane resins are often not ideal enough to gain consumers' favor.

To address the aforementioned issues, an aqueous crosslinking agent is often used alongside an aqueous polyurethane resin, and a melamine-based aqueous crosslinking agent is the most common choice for the aqueous crosslinking agent. While the moisture permeability, waterproofness, and wash durability of a film made from the aqueous polyurethane resin added with the melamine-based aqueous crosslinking agent can be enhanced compared to those made from the aqueous polyurethane resin without the melamine-based aqueous crosslinking agent, the improvement of the moisture permeability, waterproofness, and wash durability is still limited, and hence often falls short of practical needs, especially in extreme conditions such as heavy or torrential rain, where water ingress remains a concern. Moreover, after washing, the moisture permeability and waterproofness of the film significantly drops, causing the film to lose these properties.

In view of the aforesaid, there is still a need to develop an aqueous moisture-permeable waterproof composition which is free from a solvent (i.e., being eco-friendly), and which can be used to prepare a moisture-permeable waterproof element with excellent waterproofness and moisture permeability even after washing, thus having an excellent wash durability.

### SUMMARY

Therefore, an object of the present disclosure is to provide an aqueous moisture-permeable waterproof composition, which can alleviate at least one of the drawbacks of the prior art.

According to the present disclosure, the aqueous moisture-permeable waterproof composition includes an aqueous polyurethane resin having a weight average molecular weight ranging from 1000 g/mol to 10000 g/mol, an aqueous crosslinking agent, and an aqueous foaming agent. The aqueous moisture-permeable waterproof composition is free from a solvent. The aqueous crosslinking agent is present in an amount ranging from 0.1 parts by weight to 15.0 parts by weight and the aqueous foaming agent is present in an amount ranging from 0.1 parts by weight to 15.0 parts by weight, based on a total amount of the aqueous polyurethane resin as 100 parts by weight. The aqueous crosslinking agent is selected from the group consisting of an isocyanate-based aqueous crosslinking agent, an epoxy-based aqueous crosslinking agent, an aziridine-based aqueous crosslinking agent, a melamine-based aqueous crosslinking agent, and combinations thereof.

### DETAILED DESCRIPTION

For the purpose of this specification, it will be clearly understood that the word “comprising” means “including but not limited to”, and that the word “comprises” has a corresponding meaning.

It is to be understood that, if any prior art publication is referred to herein, such reference does not constitute an admission that the publication forms a part of the common general knowledge in the art, in Taiwan or any other country.

Unless otherwise defined, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

The present disclosure provides an aqueous moisture-permeable waterproof composition which includes an aqueous polyurethane resin having a weight average molecular weight ranging from 1000 g/mol to 10000 g/mol, an aqueous crosslinking agent, and an aqueous foaming agent. The aqueous moisture-permeable waterproof composition is free from a solvent. The aqueous crosslinking agent is present in an amount ranging from 0.1 parts by weight to 15.0 parts by weight and the aqueous foaming agent is present in an amount ranging from 0.1 parts by weight to 15.0 parts by weight, based on a total amount of the aqueous polyurethane resin as 100 parts by weight. The aqueous crosslinking agent is selected from the group consisting of an isocyanate-based aqueous crosslinking agent, an epoxy-based aqueous crosslinking agent, an aziridine-based aqueous crosslinking agent, a melamine-based aqueous crosslinking agent, and combinations thereof.

### <Aqueous Polyurethane Resin>

According to the present disclosure, the aqueous polyurethane resin may be used alone or in combination. In certain embodiments, the aqueous polyurethane resin is selected from the group consisting of an aqueous poly(ether urethane) resin, an aqueous poly(ester urethane) resin, an aqueous poly(carbonate urethane) resin, an aqueous poly(ether carbonate urethane) resin, an aqueous poly(ester carbonate urethane) resin, an aqueous poly(ether ester urethane) resin, and combinations thereof.

Examples of the aqueous polyurethane resin may include, but are not limited to, commercial products of Impraperm® DL series which are available from Covestro. An example of the aqueous poly(ester urethane) resin may include, but is not limited to, an anionic aliphatic polyester-polyurethane resin of Impraperm® DL 5249 which is aqueous and is available from Covestro. An example of the aqueous poly(ether carbonate urethane) resin may include, but is not limited to, a nonionic/anionic aliphatic polycarbonate-polyether polyurethane resin of Impraperm® DL 5310/1 XP which is aqueous and is available from Covestro.

### <Aqueous Crosslinking Agent>

In certain embodiments, the aqueous crosslinking agent is present in an amount ranging from 0.1 parts by weight to 8.0 parts by weight, based on a total amount of the aqueous polyurethane resin as 100 parts by weight. In other embodiments, the aqueous crosslinking agent is present in an amount ranging from 4.0 parts by weight to 8.0 parts by weight, based on a total amount of the aqueous polyurethane resin as 100 parts by weight.

### <Isocyanate-Based Aqueous Crosslinking Agent>

According to the present disclosure, the isocyanate-based aqueous crosslinking agent may be used alone or in combination. In certain embodiments, the isocyanate-based aqueous crosslinking agent is selected from the group consisting of hexamethylene diisocyanate trimer, hexamethylene diisocyanate, hexamethylene diisocyanate isocyanurate trimer, hexamethylene diisocyanate isocyanurate, and combinations thereof. When the isocyanate-based aqueous crosslinking agent includes both the hexamethylene diisocyanate trimer and the hexamethylene diisocyanate, the hexamethylene diisocyanate trimer is present in an amount ranging from 90 wt % to 99 wt %, and the hexamethylene diisocyanate is present in an amount ranging from 1 wt % to 10 wt %, based on a total amount of the isocyanate-based aqueous crosslinking agent as 100 wt %.

In certain embodiments, the isocyanate-based aqueous crosslinking agent has isocyanate groups (-NCO) in an amount ranging from 9% to 25%. In certain embodiments, the isocyanate-based aqueous crosslinking agent has an isocyanate functionality ranging from 2 to 5.

Examples of the isocyanate-based aqueous crosslinking agent may include, but are not limited to, commercial products of Coronate AQ series which are available from Tosoh Corporation and commercial products of Duranate™ series which are available from Asahi Kasei Chemicals Corporation.

Examples of the commercial products of the Coronate AQ series may include, but are not limited to, AQ-105 (content of isocyanate groups: 20.0%, isocyanate functionality: 3.4), AQ-125 (content of isocyanate groups: 16.4%, isocyanate functionality: 4.5), AQ-130 (content of isocyanate groups: 16.4%, isocyanate functionality: 4.5), AQ-140 (content of isocyanate groups: 18.1%, isocyanate functionality: 4.8), AQ 210 (content of isocyanate groups: 16.5%, isocyanate functionality: 3.2), AW-120 (content of isocyanate groups: 18.0%, isocyanate functionality: 2.5), and AQ-200 (content of isocyanate groups: 12.0%, isocyanate functionality: 2.7).

Examples of the commercial products of the Duranate™ series may include, but are not limited to, WT31-100 (content of isocyanate groups: 17.4%), WL72-100 (content of isocyanate groups: 21.1%), WB40-100 (content of isocyanate groups: 16.6%), WB40-80D (content of isocyanate groups: 13.4%), WR80-70P (content of isocyanate groups: 9.2%), and WE50-100 (content of isocyanate groups: 11.3%).

### <Epoxy-Based Aqueous Crosslinking Agent>

According to the present disclosure, the epoxy-based aqueous crosslinking agent may be used alone or in combination. In certain embodiments, the epoxy-based aqueous crosslinking agent has an epoxy equivalent ranging from 130 g/eq to 340 g/eq. In certain embodiments, the epoxy-based aqueous crosslinking agent is selected from the group consisting of an epoxy-based aromatic aqueous crosslinking agent and an epoxy-based aliphatic aqueous crosslinking agent. In certain embodiments, the epoxy-based aliphatic aqueous crosslinking agent is selected from the group consisting of trimethylolpropane triglycidyl ether, glycerol diglycidyl ether, dodecyl glycidyl ether, tridecyl glycidyl ether, ethylene glycol diglycidyl ether, diethylene glycol diglycidyl ether, tetraethylene glycol diglycidyl ether, nonaethylene glycol diglycidyl ether, propylene glycol diglycidyl ether, tripropylene glycol diglycidyl ether, heptapropylene glycol diglycidyl ether, neopentyl glycol diglycidyl ether, 1,6-hexanediol diglycidyl ether, 1,3-bis(glycidyloxy)-2-propanol, 2,2-bis(4-glycidyloxyhexyl)propane, glycerol triglycidyl ether, bisphenol A diglycidyl ether, a thermoplastic copolyester with an epoxy group,

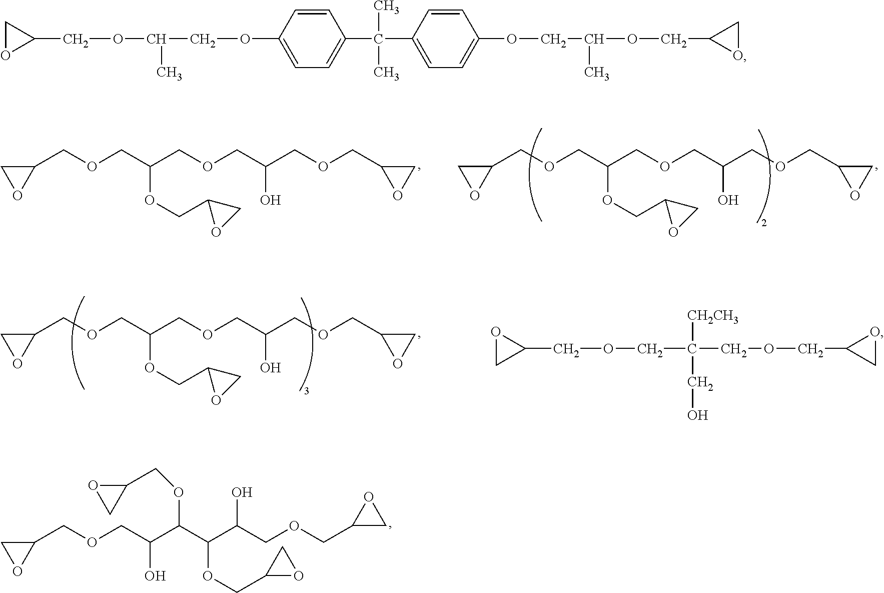

and combinations thereof.

Examples of the epoxy-based aqueous crosslinking agent may include, but are not limited to, commercial products of Epolight series which are available from Kyoeisha Chemical Co.,Ltd, commercial products of Grilbond® series which are available from EMS-CHEMIE AG, a commercial product of Griltexo 9E which is a thermoplastic copolyester with an epoxy group and is available from EMS-CHEMIE AG, and commercial products of Denacol EX series which are available from Nagase ChemteX Corporation.

Examples of the commercial products of the Epolight series may include, but are not limited to, Epolight M-1230, Epolight EHDG-L, Epolight 40E, Epolight 100E, Epolight 200E, Epolight 400E, Epolight 70P, Epolight 200P, Epolight 400P, Epolight 1500NP, Epolight 1600, Epolight 80MF, Epolight 100MF, Epolight 4000, Epolight 3002, and Epolight FR-1500.

Examples of the commercial products of the Grilbondo series may include, but are not limited to, IL-6 50% F, IL-6 60% F, and G 1701.

Examples of the commercial products of the Denacol EX series may include, but are not limited to, hydrophilic commercial products of the Denacol EX series and hydrophobic commercial products of the Denacol EX series. Examples of the hydrophilic commercial products of the Denacol EX series may include, but are not limited to, EX-612 (epoxy equivalent: 166 g/eq), EX-614 (epoxy equivalent: 167 g/eq), EX-614B (epoxy equivalent: 173 g/eq), EX-313 (epoxy equivalent: 141 g/eq), EX-314 (epoxy equivalent: 141 g/eq), EX-421 (epoxy equivalent: 159 g/eq), EX-512 (epoxy equivalent: 168 g/eq), EX-521 (epoxy equivalent: 183 g/eq), and EX-1610 (epoxy equivalent: 170 g/eq). Examples of the hydrophobic commercial products of the Denacol EX series may include, but are not limited to, EX-321 (epoxy equivalent: 140 g/eq), EX-321L (epoxy equivalent: 130 g/eq), and EX-622 (epoxy equivalent: 191 g/eq).

### <Aziridine-Based Aqueous Crosslinking Agent>

According to the present disclosure, the aziridine-based aqueous crosslinking agent may be used alone or in combination. In certain embodiments, the aziridine-based aqueous crosslinking agent is selected from the group consisting of trimethylolpropane tris[3-(aziridin-1-yl)propionate], pentaerythritol tris[3-(1-aziridinyl)propionate], trimethylolpropane tris[3-(methylaziridin-1-yl)propionate], and combinations thereof.

Examples of the aziridine-based aqueous crosslinking agent may include, but are not limited to, commercial products of NeoAdd™ PAX series which are available from Covestro, commercial products of UX series which are available from Gelie Co., Ltd., commercial products of CX series which are available from Gelie Co., Ltd., commercial products of CX series which are available from Royal Dutch State Mines (DSM) N.V., and commercial products of Xama series which are available from Bayer.

Examples of commercial products of the NeoAdd™ PAX series may include, but are not limited to, PAX-521 and PAX-523. An example of the commercial products of the UX series may include, but is not limited to, UX-1516A. Examples of the commercial products of the CX series available from Gelie Co., Ltd. may include, but are not limited to, CX-9001 and CX-9002. An Example of the commercial products of the CX series available from Royal DSM N.V. may include, but is not limited to, CX-100. Examples of the commercial products of the Xama series may include, but are not limited to, Xama-2, Xama-7, and Xama-220.

### <Melamine-Based Aqueous Crosslinking Agent>

According to the present disclosure, the melamine-based aqueous crosslinking agent may be used alone or in combination. In certain embodiments, the melamine-based aqueous crosslinking agent is selected from the group consisting of a benzoguanamine resin, a benzoguanamine formaldehyde condensate, a benzoguanamine-melamine-formaldehyde condensate, a melamine formaldehyde condensate, and combinations thereof.

Examples of the benzoguanamine formaldehyde condensate may include, but are not limited to, commercial products of Epostar™ MS, Epostar™ M05, and Epostar™ L15 which are available from Nippon Shokubai Co., Ltd. An example of the benzoguanamine-melamine-formaldehyde condensate may include, but is not limited to, a commercial product of Epostar™ M30 which is available from Nippon Shokubai Co., Ltd. Examples of the melamine formaldehyde condensate may include, but are not limited to, commercial products of Epostar™ SS, Epostar™ S, Epostar™ FS, Epostar™ S6, and Epostar™ S12 which are available from Nippon Shokubai Co., Ltd.

### <Aqueous Foaming Agent>

In certain embodiments, the aqueous foaming agent is present in an amount ranging from 0.1 parts by weight to 6.0 parts by weight, based on a total amount of the aqueous polyurethane resin as 100 parts by weight. The aqueous foaming agent is capable of imparting uniformly in basis weight and pore size to a moisture-permeable waterproof element formed from the aqueous moisture-permeable waterproof composition, thereby allowing the moisture-permeable waterproof element to exhibit excellent waterproofness, moisture permeability and wash durability. The uniformly of the basis weight means that the basis weight is consistent across various parts of the moisture-permeable waterproof element, whether from a top surface to a bottom surface or from a left side to a right side. In certain embodiments, the moisture-permeable waterproof element has a pore size ranging from 2 μm to 50 μm. In certain embodiments, the moisture-permeable waterproof element has a basis weight ranging from 5 g/m² to 100 g/m².

According to the present disclosure, the aqueous foaming agent may be used alone or in combination. In certain embodiments, the aqueous foaming agent is selected from the group consisting of a C₁-C₂₂ alkyl sulfosuccinate metal salt, a triethanolamine C₁-C₂₂ alkylbenzene sulfonate, a C₁-C₂₂ alkylbenzene sulfonate, a C₁-C₂₂ alkyl sulfonate, and combinations thereof. An example of the C₁-C₂₂ alkyl sulfosuccinate metal salt may include, but is not limited to, C₁-C₂₂ alkyl sulfosuccinate sodium salt.

Examples of the aqueous foaming agent may include, but are limited to, commercial products of Baygard® Foamer series which are available from Tanatex Chemical, a commercial product of Edolan XPS which is available from Tanatex Chemical, a commercial product of FB-18 which is available from An Fong Development Co., Ltd., Taiwan, and a commercial product of STA which is available from An Fong Development Co., Ltd., Taiwan.

Examples of the commercial products of the Baygard® Foamer series may include, but are not limited to, Baygard® Foamer 01 and Baygard® Foamer SBL.

### <Thermo-Responsive Shape Memory Polymer>

In certain embodiments, in order to enhance the waterproofness and moisture permeability of the moisture-permeable waterproof element formed from the aqueous moisture-permeable waterproof composition, the aqueous moisture-permeable waterproof composition further includes a thermo-responsive shape memory polymer.

According to the present disclosure, the thermo-responsive shape memory polymer may be used alone or in combination. In certain embodiments, the thermo-responsive shape memory polymer is selected from the group consisting of poly[4,4′-methylenebis(phenyl isocyanate)-alt-1,4-butanediol/di(propylene glycol)/polycaprolactone (CAS number: 68084-39-9), a poly(ester urethane), a polycarbonate, and combinations thereof. The poly(ester urethane) is formed by subjecting 4,4′-diphenylmethane diisocyanate, 1,4-butanediol, polytetramethylene glycol having a weight average molecular weight ranging from 1000 g/mol to 4000 g/mol, polycaprolactone polyol having a weight average molecular weight ranging from 1000 g/mol to 4000 g/mol, and polyethylene glycol having a weight average molecular weight ranging from 1000 g/mol to 4000 g/mol to a polymerization reaction.

Examples of the thermo-responsive shape memory polymer may include, but are not limited to, commercial products of NGM-Ether type series, NGS-Solution type series, and NGP (nanographene platelets)-Potting type series which are available from Nanografi Nano Technology.

Examples of the commercial products of the NGM-Ether type series may include, but are not limited to, NGM2520, NGM6520, NGM5520, NGM9020, and NGM7520. Examples of the commercial products of the NGS-Solution type series may include, but are not limited to, NGS4520, NGS3520, and NGS2520. Examples of the commercial products of the NGP-Potting type series may include, but are not limited to, NGP4510, NGP5510, NGP3510, and NGP2510.

In certain embodiments, the thermo-responsive shape memory polymer is present in an amount ranging from 0.1 parts by weight to 15.0 parts by weight, based on a total amount of the aqueous polyurethane resin as 100 parts by weight. In certain embodiments, the thermo-responsive shape memory polymer is present in an amount ranging from 0.1 parts by weight to 5.0 parts by weight, based on a total amount of the aqueous polyurethane resin as 100 parts by weight.

According to the present disclosure, the aqueous moisture-permeable waterproof composition can be used to prepare the moisture-permeable waterproof element suitable for products that require both waterproofness and moisture permeability. Examples of the products may include, but are not limited to, moisture-permeable waterproof clothing, moisture-permeable waterproof knitted shoes, moisture-permeable waterproof leather shoes, moisture-permeable waterproof gloves, moisture-permeable waterproof sleevelets, moisture-permeable waterproof hats, and moisture-permeable waterproof socks.

The disclosure will be further described by way of the following examples. However, it should be understood that the following examples are solely intended for the purpose of illustration and should not be construed as limiting the disclosure in practice.

### Examples

### Example 1 (EX1)

50 parts by weight of a nonionic aliphatic polycarbonate-polyether polyurethane resin (serving as an aqueous polyurethane resin, manufacturer: Covestro, model no.: Impraperm® DL 5310/1 XP, being aqueous, molecular weight (Mw): 2000 g/mol, hereafter abbreviated as Impraperm® DL 5310/1 XP), 50 parts by weight of an anionic aliphatic polyester-polyurethane resin (serving as an aqueous polyurethane resin, manufacturer: Covestro, model no.: Impraperm® DL 5249, being aqueous, molecular weight (Mw): 1000 g/mol, hereafter abbreviated as Impraperm® DL 5249), 8 parts by weight of hexamethylene diisocyanate trimer (serving as an isocyanate-based aqueous crosslinking agent, manufacturer: Tosoh Corporation, model no.: Coronate AQ-105, CAS number: 28574905, hereafter abbreviated as Coronate AQ-105), 6 parts by weight of triethanolamine alkylbenzene sulfonate (serving as an aqueous foaming agent, manufacturer: Tanatex Chemical, model no.: Baygard® Foamer SBL, hereafter abbreviated as Baygard® Foamer SBL), and 5 parts by weight of a poly(ester urethane) (serving as a thermo-responsive shape memory polymer, manufacturer: Nanografi Nano Technology, model no.: NGM2520, weight average molecular weight: 9000 g/mol, hereafter abbreviated as NGM2520) were mixed at a temperature of 20° C.±5° C. and a rotational speed of 500 rpm, so as to obtain an aqueous moisture-permeable waterproof composition of EX1.

To be specific, the poly(ester urethane) is formed by subjecting 4,4′-diphenylmethane diisocyanate, 1,4-butanediol, a polytetramethylene glycol having a weight average molecular weight of 3000 g/mol, a polycaprolactone polyol having a weight average molecular weight of 2800 g/mol, and a polyethylene glycol having a weight average molecular weight of 3200 g/mol to a polymerization reaction.

### Examples 2 to 24 (EX2 to EX24)

The procedures for preparing the aqueous moisture-permeable waterproof compositions of EX2 to EX24 were similar to those of EX1, except that the type of materials and the amounts thereof were varied as shown in Tables 1, 3 and 4. To be specific, in EX2 and EX5, the trimethylolpropane triglycidyl ether (manufacturer: Kyoeisha Chemical Co.,Ltd, model no.: Epolight 100MF, hereafter abbreviated as Epolight 100MF) was used to serve as the epoxy-based aqueous crosslinking agent. In EX3 and EX8, the melamine formaldehyde condensate (manufacturer: Nippon Shokubai Co., Ltd, model no.: Epostar™ SS, hereafter abbreviated as Epostar™ SS) was used to serve as the melamine-based aqueous crosslinking agent. In EX4 and EX6, the trimethylolpropane tris[3-(aziridin-1-yl)propionate](manufacturer: Bayer, model no.: Xama-2, hereafter abbreviated as Xama-2) was used to serve as the aziridine-based aqueous crosslinking agent. In EX9, EX13, EX17, and EX21, the hexamethylene diisocyanate isocyanurate trimer (manufacturer: Asahi Kasei Chemicals Corporation, model no.: Duranate™ WL72-100, CAS number: 3779-63-3, hereafter abbreviated as Duranate™ WL72-100) was used to serve as the isocyanate-based aqueous crosslinking agent. In EX10, EX14, EX18, and EX22, the

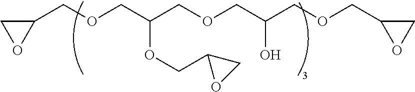

(manufacturer: Nagase ChemteX Corporation, model no.: Denacol EX-521, hereafter abbreviated as Denacol EX-521) was used to serve as the epoxy-based aqueous crosslinking agent. In EX11, EX15, EX19, and EX23, the benzoguanamine formaldehyde condensate (manufacturer: Nippon Shokubai Co., Ltd, model no.: Epostar™ L15, hereafter abbreviated as Epostar™ L15) was used to serve as the melamine-based aqueous crosslinking agent. In EX12, EX16, EX20, EX24, the pentaerythritol tris[3-(1-aziridinyl)propionate](manufacturer: Gelie Co., Ltd., model no.: UX-1516A, hereafter abbreviated as UX-1516A) was used to serve as the aziridine-based aqueous crosslinking agent. In EX13 to EX16 and EX21 to EX24, the butylbenzene sulfonate and hexylbenzene sulfonate (manufacturer: An Fong Development Co., Ltd., Taiwan, model no.: FB-18, hereafter abbreviated as FB-18) were used to serve as the aqueous foaming agent. In EX17 to EX24, the polycarbonate (manufacturer: Nanografi Nano Technology, model no.: NGP4510, weight average molecular weight: 3000 g/mol, hereafter abbreviated as NGP4510) was used to serve as the thermo-responsive shape memory polymer.

### Comparative Examples 1 to 3 (CE1 to CE3)

The procedures for preparing the aqueous moisture-permeable waterproof compositions of CE1 to CE3 were similar to those of EX1, except that the type of materials and the amounts thereof were varied as shown in Table 2. To be specific, in CE1 and CE2, the aqueous polyurethane resin was replaced by the polypropylene glycol (serving as the solvent-containing resin, manufacturer: Coating P. Materials Co., Ltd., model no.: NC-5025, weight average molecular weight: 1000 g/mol to 6000 g/mol, hereafter abbreviated as NC-5025). In addition, in CE1 to CE3, the aqueous foaming agent was not used in the procedures.

The materials and the amounts thereof for preparing the aqueous moisture-permeable waterproof compositions of EX1 to EX24 and CE1 to CE3 are summarized in Tables 1 to 4 below.

TABLE 1

| | | | EX | EX | EX | EX | EX | EX | EX | EX |
|---|---|---|---|---|---|---|---|---|---|---|
| | | | 1 | 2 | 3 | 4 | 5 | 6 | 7 | 8 |
| Aqueous polyurethane resin | | Impraperm ® | 50 | 50 | 50 | 50 | 50 | 50 | 70 | 50 |
| | | DL 5310/1 XP | | | | | | | | |
| | | Impraperm ® | 50 | 50 | 50 | 50 | 50 | 50 | 30 | 50 |
| | | DL 5249 | | | | | | | | |
| Isocyanate- | Aqueous | Coronate | 8 | 0 | 0 | 0 | 4 | 4 | 8 | 0 |
| based | crosslinking | AQ-105 | | | | | | | | |
| Epoxy- | agent | Epolight | 0 | 8 | 0 | 0 | 4 | 0 | 0 | 0 |
| based | | 100MF | | | | | | | | |
| Melamine- | | Epostar ™ | 0 | 0 | 8 | 0 | 0 | 0 | 0 | 8 |
| based | | SS | | | | | | | | |
| Aziridine- | | Xama-2 | 0 | 0 | 0 | 8 | 0 | 4 | 0 | 0 |
| based | | | | | | | | | | |

| | | | | | | | | | |
|---|---|---|---|---|---|---|---|---|---|
| Aqueous foaming agent | Baygard ® | 6 | 6 | 6 | 6 | 6 | 6 | 6 | 6 |
| | Foamer SBL | | | | | | | | |
| Thermo-responsive shape | NGM2520 | 5 | 5 | 4 | 5 | 5 | 5 | 5 | 0 |
| memory polymer | | | | | | | | | |
| Solvent-containing resin | NC-5025 | 0 | 0 | 0 | 0 | 0 | 0 | 0 | 0 |

TABLE 2

| | | | CE1 | CE2 | CE3 |
|---|---|---|---|---|---|
| Aqueous polyurethane resin | | Impraperm ® | 0 | 0 | 50 |
| | | DL | | | |
| | | 5310/1 XP | | | |
| | | Impraperm ® | 0 | 0 | 50 |
| | | DL 5249 | | | |
| Isocyanate-based | Aqueous | Coronate | 0 | 0 | 0 |
| | crosslinking | AQ-105 | | | |
| Epoxy-based | agent | Epolight | 0 | 0 | 0 |
| | | 100MF | | | |
| Melamine-based | | Epostar ™ | 8 | 10 | 1 |
| | | SS | | | |
| Aziridine-based | | Xama-2 | 0 | 0 | 0 |

| Aqueous foaming agent | Baygard ® | 0 | 0 | 0 |
|---|---|---|---|---|
| | Foamer | | | |
| | SBL | | | |
| Thermo-responsive | NGM2520 | 0 | 0 | 0 |
| shape memory polymer | | | | |
| Solvent-containing resin | NC-5025 | 80 | 100 | 0 |

TABLE 3

| | | | EX | EX | EX | EX | EX | EX | EX | EX |
|---|---|---|---|---|---|---|---|---|---|---|
| | | | 9 | 10 | 11 | 12 | 13 | 14 | 15 | 16 |
| Aqueous polyurethane resin | | Impraperm ® | 50 | 50 | 50 | 50 | 50 | 50 | 50 | 50 |
| | | DL 5310/1 XP | | | | | | | | |
| | | Impraperm ® | 50 | 50 | 50 | 50 | 50 | 50 | 50 | 50 |
| | | DL 5249 | | | | | | | | |
| Isocyanate- | Aqueous | Duranate ™ | 8 | 0 | 0 | 0 | 8 | 0 | 0 | 0 |
| based | crosslinking | WL72-100 | | | | | | | | |
| Epoxy- | agent | Denacol | 0 | 8 | 0 | 0 | 0 | 8 | 0 | 0 |
| based | | EX-521 | | | | | | | | |
| Melamine- | | Epostar ™ | 0 | 0 | 8 | 0 | 0 | 0 | 8 | 0 |
| based | | L15 | | | | | | | | |
| Aziridine- | | UX-1516A | 0 | 0 | 0 | 8 | 0 | 0 | 0 | 8 |
| based | | | | | | | | | | |

| | | | | | | | | | |
|---|---|---|---|---|---|---|---|---|---|
| Aqueous foaming agent | Baygard ® | 6 | 6 | 6 | 6 | 0 | 0 | 0 | 0 |
| | Foamer SBL | | | | | | | | |
| | FB-18 | 0 | 0 | 0 | 0 | 6 | 6 | 6 | 6 |
| Thermo-responsive shape | NGM2520 | 5 | 5 | 4 | 5 | 5 | 5 | 4 | 5 |
| memory polymer | | | | | | | | | |

TABLE 4

| | | | EX | EX | EX | EX | EX | EX | EX | EX |
|---|---|---|---|---|---|---|---|---|---|---|
| | | | 17 | 18 | 19 | 20 | 21 | 22 | 23 | 24 |
| Aqueous polyurethane resin | | Impraperm ® | 50 | 50 | 50 | 50 | 50 | 50 | 50 | 50 |
| | | DL 5310/1 XP | | | | | | | | |
| | | Impraperm ® | 50 | 50 | 50 | 50 | 50 | 50 | 50 | 50 |
| | | DL 5249 | | | | | | | | |
| Isocyanate- | Aqueous | Duranate ™ | 8 | 0 | 0 | 0 | 8 | 0 | 0 | 0 |
| based | crosslinking | WL72-100 | | | | | | | | |
| Epoxy- | agent | Denacol | 0 | 8 | 0 | 0 | 0 | 8 | 0 | 0 |
| based | | EX-521 | | | | | | | | |
| Melamine- | | Epostar ™ | 0 | 0 | 8 | 0 | 0 | 0 | 8 | 0 |
| based | | L15 | | | | | | | | |
| Aziridine- | | UX-1516A | 0 | 0 | 0 | 8 | 0 | 0 | 0 | 8 |
| based | | | | | | | | | | |

| | | | | | | | | | |
|---|---|---|---|---|---|---|---|---|---|
| Aqueous foaming agent | Baygard ® | 6 | 6 | 6 | 6 | 0 | 0 | 0 | 0 |
| | Foamer SBL | | | | | | | | |
| | FB-18 | 0 | 0 | 0 | 0 | 6 | 6 | 6 | 6 |
| Thermo-responsive shape | NGP4510 | 5 | 5 | 4 | 5 | 5 | 5 | 4 | 5 |
| memory polymer | | | | | | | | | |

### Property Evaluation

### A. Preparation of Test Sample

First, the aqueous moisture-permeable waterproof composition of a respective one of EX1 to EX24 and CE1 to CE3 was applied to a release paper, so as to form a first laminated body. Next, the first laminated body was placed in an oven set at a temperature of 130° C.±10° C. for 7.5 minutes±2.5 minutes to allow the first laminated body to undergo a dehydration treatment, so as to obtain a second laminated body containing the release paper and a coating film having a thickness of 30 μm±5 μm. Thereafter, a surface of the coating film in the second laminated body was bonded to a surface of a polyester fabric having a thickness of 0.45 mm±0.05 mm, and then left to stand for 24 hours, so as obtain a third laminated body. Then, the release paper was peeled off from the third laminated body, so as to obtain a test sample of a respective one of EX1 to EX24 and CE1 to CE3.

### B. Determination of Resistance to Hydrostatic Pressure Before Washing

For the test sample of the respective one of EX1 to EX24 and CE1 to CE3 prepared in section A of “Property evaluation”, the resistance to hydrostatic pressure before washing was determined using a digital hydrostatic head tester (manufacturer: Cometech Testing Machines Co., Ltd., model no.: QC-317F) in accordance with the procedures set forth in the standard test method for water resistance of textiles, i.e., JIS L1092 B1 (published in 2009). The results are shown in Tables 5 to 8 below.

C. Determination of Resistance to Hydrostatic Pressure after Washing

First, in accordance with the procedures set forth in AATCC LP1 (published in 2021), two test samples of the respective one of EX1 to EX24 and CE1 to CE3 prepared in section A of “Property evaluation” were subjected to a washing treatment for 5 times and 10 times, respectively, using an AATCC standard shrinking test washing machine (manufacturer: Fineetex Co. Ltd., model no.: Labtex LBT-M6) under normal washing conditions with tap water, so as to obtain a 5-times washed test sample and a 10-times washed test sample of a respective one of EX1 to EX24 and CE1 to CE3.

Next, for the 5-times washed test sample and the 10-times washed test sample of the respective one of EX1 to EX24 and CE1 to CE3, the resistance to hydrostatic pressure after washing was determined using the digital hydrostatic head tester in accordance with the procedures set forth in the standard test method for water resistance of textiles, i.e., JIS L1092B1 (published in 2009). The results are shown in Tables 5 to 8 below.

### D. Determination of Moisture Permeability Before Washing

For a test sample of the respective one of EX1 to EX24 and CE1 to CE3 prepared in section A of “Property evaluation”, the moisture permeability before washing was determined using a water vapour permeability testing machine (manufacturer: Perfect International Instruments Co., Ltd., model no.: PT-50B1) at water temperature of 23° C. and ambient temperature of 25° C., 30° C., or 40° C. in accordance with the procedures set forth in the standard test method for water vapour permeability of textiles, i.e., JIS L 1099B1 (published in 2012). The results are shown in Tables 5 to 8 below.

E. Determination of Moisture Permeability after Washing

First, in accordance with the procedures set forth in AATCC LP1 (published in 2021), two test samples of the respective one of EX1 to EX24 and CE1 to CE3 prepared in section A of “Property evaluation” were subjected to a washing treatment for 5 times and 10 times, respectively, using the AATCC standard shrinking test washing machine under normal washing conditions with tap water, so as to obtain a 5-times washed test sample and a 10-times washed test sample of the respective one of EX1 to EX24 and CE1 to CE3.

Next, for the 5-times washed test sample and the 10-times washed test sample of the respective one of EX1 to EX24 and CE1 to CE3, the moisture permeability after washing was determined using the water vapour permeability testing machine at water temperature of 23° C. and ambient temperature of 25° C., 30° C., or 40° C. in accordance with the procedures set forth in the standard test method for water vapour permeability of textiles, i.e., JIS L 10991B1 (published in 2012). The results are shown in Tables 5 to 8 below.

### Results

TABLE 5

| | | | EX | EX | EX | EX | EX | EX | EX | EX |
|---|---|---|---|---|---|---|---|---|---|---|
| | | | 1 | 2 | 3 | 4 | 5 | 6 | 7 | 8 |
| Resistance to | Before washing | | 15 | 15 | 15 | 15 | 20 | 20 | 20 | 15 |
| hydrostatic | After washing 5 times | | 15 | 15 | 15 | 15 | 20 | 20 | 20 | 15 |
| pressure (×10³, | After washing 10 times | | 15 | 15 | 15 | 15 | 20 | 20 | 20 | 15 |
| mmH₂O/cm²) | | | | | | | | | | |
| Moisture | Before washing | 25° C. | 15 | 15 | 15 | 15 | 20 | 20 | 20 | 15 |
| permeability | | 30° C. | 35 | 35 | 15 | 35 | 35 | 35 | 35 | 15 |
| (×10³, g/m² · | | 40° C. | 50 | 50 | 15 | 50 | 50 | 50 | 50 | 15 |
| 24 hrs) | After washing | 25° C. | 15 | 15 | 15 | 15 | 20 | 20 | 20 | 15 |
| | 5 times | | | | | | | | | |
| | After washing | 25° C. | 15 | 15 | 15 | 15 | 20 | 20 | 20 | 15 |
| | 10 times | 30° C. | 35 | 35 | 15 | 35 | 35 | 35 | 35 | 15 |
| | | 40° C. | 50 | 50 | 15 | 50 | 50 | 50 | 50 | 15 |

TABLE 6

| | | | CE1 | CE2 | CE3 |
|---|---|---|---|---|---|
| Resistance to | Before washing | | 10 | 10 | 10 |
| hydrostatic | After washing 5 | | 5 | 6 | 10 |
| pressure | times | | | | |
| (×10³, | | | | | |
| mmH₂O/cm²) | After washing 10 | | 2 | 3 | 10 |
| | times | | | | |
| Moisture | Before | 25° C. | 2 | 10 | 10 |
| permeability | washing | 30° C. | 10 | 10 | 10 |
| (×10³, | | 40° C. | 10 | 10 | 10 |
| g/m² · 24 hrs) | After | 25° C. | 8 | 8 | 10 |
| | washing 5 | | | | |
| | times | | | | |
| | After | 25° C. | 6 | 6 | 10 |
| | washing 10 | 30° C. | 10 | 10 | 10 |
| | times | 40° C. | 10 | 10 | 10 |

TABLE 7

| | | | EX | EX | EX | EX | EX | EX | EX | EX |
|---|---|---|---|---|---|---|---|---|---|---|
| | | | 9 | 10 | 11 | 12 | 13 | 14 | 15 | 16 |
| Resistance to | Before washing | | 15 | 15 | 15 | 15 | 15 | 15 | 15 | 15 |
| hydrostatic | After washing 5 times | | 15 | 15 | 15 | 15 | 15 | 15 | 15 | 15 |
| pressure (×10³, | After washing 10 times | | 15 | 15 | 15 | 15 | 15 | 15 | 15 | 15 |
| mmH₂O/cm²) | | | | | | | | | | |
| Moisture | Before washing | 25° C. | 15 | 15 | 15 | 15 | 15 | 15 | 15 | 15 |
| permeability | | 30° C. | 35 | 35 | 15 | 35 | 35 | 35 | 15 | 35 |
| (×10³, g/m² · | | 40° C. | 50 | 50 | 15 | 50 | 50 | 50 | 15 | 50 |
| 24 hrs) | After washing | 25° C. | 15 | 15 | 15 | 15 | 15 | 15 | 15 | 15 |
| | 5 times | | | | | | | | | |
| | After washing | 25° C. | 15 | 15 | 15 | 15 | 15 | 15 | 15 | 15 |
| | 10 times | 30° C. | 35 | 35 | 15 | 35 | 35 | 35 | 15 | 35 |
| | | 40° C. | 50 | 50 | 15 | 50 | 50 | 50 | 15 | 50 |

TABLE 8

| | | | EX | EX | EX | EX | EX | EX | EX | EX |
|---|---|---|---|---|---|---|---|---|---|---|
| | | | 17 | 18 | 19 | 20 | 21 | 22 | 23 | 24 |
| Resistance to | Before washing | | 15 | 15 | 15 | 15 | 15 | 15 | 15 | 15 |
| hydrostatic | After washing 5 times | | 15 | 15 | 15 | 15 | 15 | 15 | 15 | 15 |
| pressure (×10³, | After washing 10 times | | 15 | 15 | 15 | 15 | 15 | 15 | 15 | 15 |
| mmH₂O/cm²) | | | | | | | | | | |
| Moisture | Before washing | 25° C. | 15 | 15 | 15 | 15 | 15 | 15 | 15 | 15 |
| permeability | | 30° C. | 35 | 35 | 15 | 35 | 35 | 35 | 15 | 35 |
| (×10³, g/m² · | | 40° C. | 50 | 50 | 15 | 50 | 50 | 50 | 15 | 50 |
| 24 hrs) | After washing | 25° C. | 15 | 15 | 15 | 15 | 15 | 15 | 15 | 15 |
| | 5 times | | | | | | | | | |
| | After washing | 25° C. | 15 | 15 | 15 | 15 | 15 | 15 | 15 | 15 |
| | 10 times | 30° C. | 35 | 35 | 15 | 35 | 35 | 35 | 15 | 35 |
| | | 40° C. | 50 | 50 | 15 | 50 | 50 | 50 | 15 | 50 |

Referring to Tables 5 to 8, the resistance to hydrostatic pressure and the moisture permeability before washing of the test sample of a respective one of EX1 to EX24 were substantially greater than those of a respective one of CE1 to CE3. In addition, the resistance to hydrostatic pressure and the moisture permeability after washing for both the 5-times washed and 10-times washed test samples of a respective one of EX1 to EX24 were substantially greater than those of a respective one of CE1 to CE3.

To be specific, the resistance to hydrostatic pressure after washing for both the 5-times washed and 10-times washed test samples of the respective one of EX1 to EX24 were the same as that before washing of the test sample of the respective one of EX1 to EX24. However, compared with the resistance to hydrostatic pressure before washing of the test sample of the respective one of CE1 and CE2, the resistance to hydrostatic pressure after washing for both the 5-times washed and 10-times washed test samples of the respective one of CE1 and CE2 progressively decreased as the number of the washing treatments increased. With regard to the determination of moisture permeability, similar results were observed with respect to EX1 to EX24. These results demonstrate that the test sample of the respective one of EX1 to EX24, which was made from the corresponding aqueous moisture-permeable waterproof composition of a respective one of EX1 to EX24, was able to exhibit excellent waterproofness and moisture permeability before and after washing, and hence has an excellent wash durability.

Summarizing the above test results, it is clear that by virtue of the materials (particularly the aqueous polyurethane resin which is free from a solvent, the aqueous foaming agent and the thermo-responsive shape memory polymer) and the amounts thereof used for preparing the aqueous moisture-permeable waterproof composition, the aqueous moisture-permeable waterproof composition of the present disclosure is free from a solvent and is eco-friendly, and the moisture-permeable waterproof element formed from the aqueous moisture-permeable waterproof composition of the present disclosure can exhibit excellent waterproofness and moisture permeability before and after washing, and hence has an excellent wash durability.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, the one or more features may be singled out and practiced alone without the another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An aqueous moisture-permeable waterproof composition, comprising:
an aqueous polyurethane resin having a weight average molecular weight ranging from 1000 g/mol to 10000 g/mol;
an aqueous crosslinking agent; and
an aqueous foaming agent;
the aqueous moisture-permeable waterproof composition being free from a solvent;
wherein the aqueous crosslinking agent is present in an amount ranging from 0.1 parts by weight to 15.0 parts by weight and the aqueous foaming agent is present in an amount ranging from 0.1 parts by weight to 15.0 parts by weight, based on a total amount of the aqueous polyurethane resin as 100 parts by weight; and
wherein the aqueous crosslinking agent is selected from the group consisting of an isocyanate-based aqueous crosslinking agent, an epoxy-based aqueous crosslinking agent, an aziridine-based aqueous crosslinking agent, a melamine-based aqueous crosslinking agent, and combinations thereof.

2. The aqueous moisture-permeable waterproof composition as claimed in claim 1, wherein the aqueous foaming agent is present in an amount ranging from 0.1 parts by weight to 6.0 parts by weight, based on a total amount of the aqueous polyurethane resin as 100 parts by weight.

3. The aqueous moisture-permeable waterproof composition as claimed in claim 1, wherein the aqueous foaming agent is selected from the group consisting of a C₁-C₂₂ alkyl sulfosuccinate metal salt, a triethanolamine C₁-C₂₂ alkylbenzene sulfonate, a C₁-C₂₂ alkylbenzene sulfonate, a C₁-C₂₂ alkyl sulfonate, and combinations thereof.

4. The aqueous moisture-permeable waterproof composition as claimed in claim 1, wherein the isocyanate-based aqueous crosslinking agent is selected from the group consisting of hexamethylene diisocyanate trimer, hexamethylene diisocyanate, hexamethylene diisocyanate isocyanurate trimer, hexamethylene diisocyanate isocyanurate, and combinations thereof.

5. The aqueous moisture-permeable waterproof composition as claimed in claim 1, wherein the epoxy-based aqueous crosslinking agent is selected from the group consisting of trimethylolpropane triglycidyl ether, glycerol diglycidyl ether, dodecyl glycidyl ether, tridecyl glycidyl ether, ethylene glycol diglycidyl ether, diethylene glycol diglycidyl ether, tetraethylene glycol diglycidyl ether, nonaethylene glycol diglycidyl ether, propylene glycol diglycidyl ether, tripropylene glycol diglycidyl ether, heptapropylene glycol diglycidyl ether, neopentyl glycol diglycidyl ether, 1,6-hexanediol diglycidyl ether, 1,3-bis(glycidyloxy)-2-propanol, 2,2-bis(4-glycidyloxyhexyl)propane, glycerol triglycidyl ether, bisphenol A diglycidyl ether, a thermoplastic copolyester with an epoxy group, 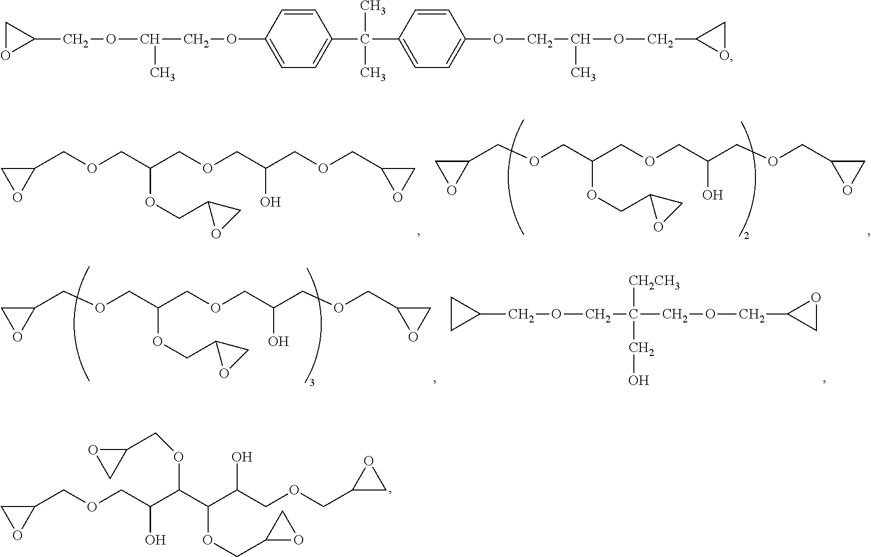
and combinations thereof.

6. The aqueous moisture-permeable waterproof composition as claimed in claim 1, wherein the aziridine-based aqueous crosslinking agent is selected from the group consisting of trimethylolpropane tris[3-(aziridin-1-yl)propionate], pentaerythritol tris[3-(1-aziridinyl)propionate], trimethylolpropane tris[3-(methylaziridin-1-yl)propionate], and combinations thereof.

7. The aqueous moisture-permeable waterproof composition as claimed in claim 1, wherein the melamine-based aqueous crosslinking agent is selected from the group consisting of a benzoguanamine resin, a benzoguanamine formaldehyde condensate, a benzoguanamine-melamine-formaldehyde condensate, a melamine formaldehyde condensate, and combinations thereof.

8. The aqueous moisture-permeable waterproof composition as claimed in claim 1, wherein the aqueous polyurethane resin is selected from the group consisting of an aqueous poly(ether urethane) resin, an aqueous poly(ester urethane) resin, an aqueous poly(carbonate urethane) resin, an aqueous poly(ether carbonate urethane) resin, an aqueous poly(ester carbonate urethane) resin, an aqueous poly(ether ester urethane) resin, and combinations thereof.

9. The aqueous moisture-permeable waterproof composition as claimed in claim 1, further comprising a thermo-responsive shape memory polymer.

10. The aqueous moisture-permeable waterproof composition as claimed in claim 9, wherein the thermo-responsive shape memory polymer is selected from the group consisting of a poly[4,4′-methylenebis(phenyl isocyanate)-alt-1,4-butanediol/di(propylene glycol)/polycaprolactone, a poly(ester urethane), a polycarbonate, and combinations thereof, the poly(ester urethane) being formed by subjecting 4,4′-diphenylmethane diisocyanate, 1,4-butanediol, a polytetramethylene glycol having a weight average molecular weight ranging from 1000 g/mol to 4000 g/mol, a polycaprolactone polyol having a weight average molecular weight ranging from 1000 g/mol to 4000 g/mol, and a polyethylene glycol having a weight average molecular weight ranging from 1000 g/mol to 4000 g/mol to a polymerization reaction.
